(19) United States
(12) Patent Application Publication
(10) Pub. No.: US 2006/0140199 A1
(43) Pub. Date: Jun. 29, 2006

(54) SIP/UPnP bridging middleware architecture for a service gateway framework

(75) Inventors: Yue Ma, West Windsor, NJ (US); Dennis Bushmitch, Somerset, NJ (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/159,061

(22) Filed: Jun. 22, 2005

Related U.S. Application Data
(63) Continuation-in-part of application No. 11/023,752, filed on Dec. 28, 2004.

(51) Int. Cl. H04L 12/56; H04L 12/28; H04L 12/66

(52) U.S. Cl. 370/401; 370/352

(57) ABSTRACT

A bridging architecture is provided for a network gateway environment which provides service registration in accordance with a gateway framework, such as OSGi. The bridging architecture includes: a SIP service registered with the gateway framework and operable to import and export SIP capabilities into the network gateway environment; a UPnP service registered with the gateway framework and operable to import UPnP capabilities into the network gateway environment; and a SIP/UPnP bridging middleware registered with the gateway framework and with the SIP service as a SIP user agent. The bridging middleware provides a communication interface between SIP entities residing outside the network gateway environment and UPnP entities residing within the network gateway environment.

### CROSS-REFERENCE TO RELATED APPLICATIONS

This application is a continuation-in-part of U.S. patent application Ser. No. 11/023,752 filed on Dec. 28, 2004. The disclosure of the above application is incorporated herein by reference.

### FIELD OF THE INVENTION

The present invention relates generally to a bridging middleware architecture that interfaces SIP-based mobile devices outside of a service gateway framework, such as OSGi, with UPnP devices residing in the service gateway framework.

### BACKGROUND OF THE INVENTION

UPnP technology establishes protocols that allow networked devices to interact with each other. UPnP architecture consists of a set of standardized protocols that each network device implements to provide discovery, control and data transfer between such devices. Due to the nature of UPnP service discovery and eventing mechanisms, UPnP technology is limited to network devices that are connected in a network environment where multicasting is supported. In addition, UPnP does not readily support communication with devices outside of the network environment.

In contrast, Session Initiation Protocol (SIP) is a well known application-layer control protocol which is commonly used for call setup and management associated with Internet Protocol (IP) telephone services. However, SIP is becoming increasingly employed in other applications, such as next generation mobile devices. These applications can be traced to SIP support for device mobility and location independence, wide area service mobility and strengthened security. SIP also supports event notification which is critical for device control applications.

The evolution of these types of mobile and home networking technologies offer opportunities for supporting the interoperation between mobile devices and devices residing in a home network. Interoperation is meant to be the ability for mobile devices, such as cell phones and PDAs, to discover, connect, control and interact with the devices in a home network. SIP provides an excellent conduit for enabling interoperation between mobile devices and devices residing in home network environment. However, there is a need for a bridging architecture that will interface SIP-based mobile devices with UPnP compliant devices residing in a home network environment. In particular, a bridging architecture that integrates with the gateway framework of the network environment.

### SUMMARY OF THE INVENTION

A bridging architecture is provided for a network gateway environment which provides service registration in accordance with a gateway framework, such as OSGi. The bridging architecture includes: a SIP service registered with the gateway framework and operable to import and export SIP capabilities into the network gateway environment; a UPnP service registered with the gateway framework and operable to import UPnP capabilities into the network gateway environment; and a SIP/UPnP bridging middleware registered with the gateway framework and with the SIP service as a SIP user agent. The bridging middleware provides a communication interface between SIP entities residing outside the network gateway environment and UPnP entities residing within the network gateway environment.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 depicts an exemplary bridging architecture for a network gateway environment according to the principles of the present invention;

FIG. 2 depicts an exemplary SIP Service which is incorporated into a services gateway framework;

FIG. 3 illustrates the hierarchy of the UPnP framework;

FIG. 4A illustrates a request by a mobile network device for a list of existing UPnP devices and associated services in accordance with the present invention;

FIG. 4B illustrates how a mobile network device retrieves the details of selected UPnP devices in accordance with the present invention;

FIG. 4C illustrates how a mobile network device retrieves the details of selected UPnP services in accordance with the present invention;

FIG. 4D illustrates how a mobile network device invokes specific UPnP actions in accordance with the present invention; and

FIG. 4E illustrates how a mobile network device gets the details of state variables in accordance with the present invention.

### DETAILED DESCRIPTION OF THE PREFERRED EMBODIMENTS

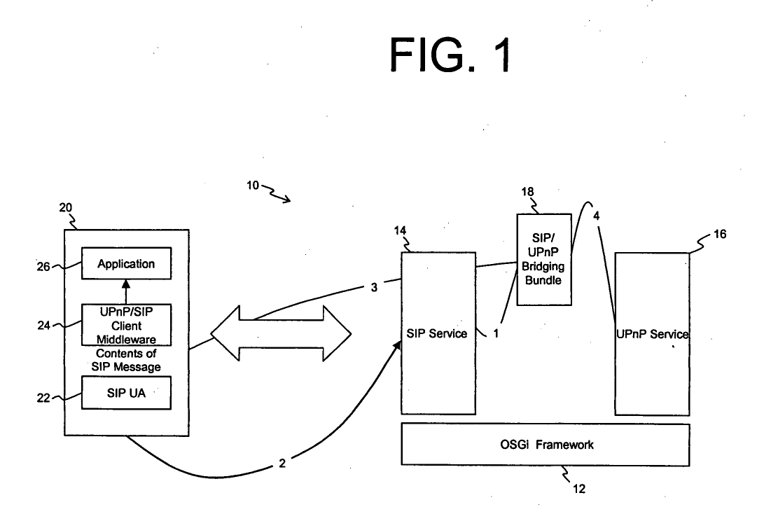

FIG. 1 illustrates an exemplary bridging architecture 10 for a network gateway environment according to the principles of the present invention. The bridging architecture is supported by a services gateway framework 12, such as the Open Services Gateway Initiative (OSGi). In a service gateway framework, applications are designed as a set of services, with each service implementing a segment of the overall functionality. These services are then packaged into an executable component commonly referred to as a bundle. The gateway framework handles basic bundle management functionality. In order to share its services with other bundles, a bundle can register any number of services with the framework. While the following description is provided with reference to OSGi, it is readily understood that other service gateway frameworks which provide service registration and discovery are also within the scope of the present invention.

The bridging architecture 10 is generally comprised of a SIP Service 14, an UPnP Device Service 16 and a SIP/UPnP bridging middleware 18. Each of these entities is registered with the gateway framework. In the context of OSGi, these entities register with a service registry.

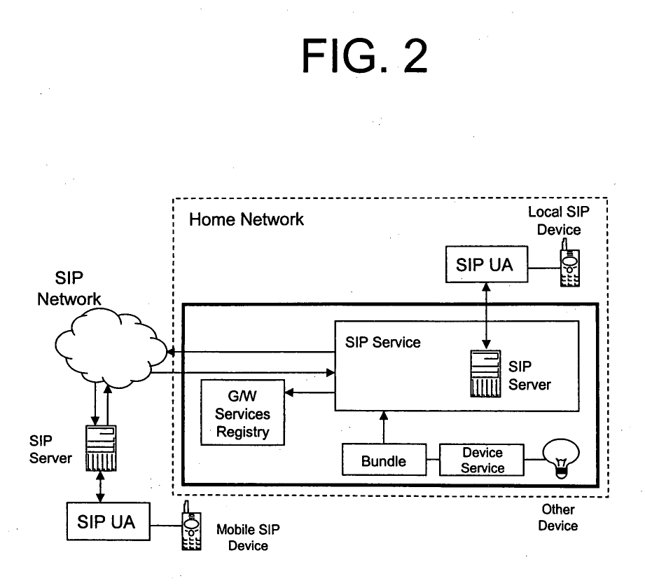

Session initiation protocol (SIP) is a well known call setup and management protocol for multimedia communication and the SIP Service operates in accordance with this protocol. Briefly, the SIP Service 14 provides importation and exportation of SIP capabilities into the gateway framework. The SIP Service 14 exposes different interfaces which deal with SIP-specific functions, such as registration, eventing and messaging, as well as gateway-specific functions, such as SIP device registration with the framework's registry. An exemplary SIP Service 14 which is incorporated into a services gateway framework is shown in FIG. 2. Further information regarding this exemplary SIP Service may be found in U.S. patent application Ser. No. 10/894,469 entitled “SIP Service for Home Network Device and Service Mobility” which is incorporated by reference herein.

The UPnP Device Service 16 implements the UPnP protocols in the service gateway framework and handles the interaction with bundles that use the UPnP devices. More specifically, the UPnP Device Service discovers UPnP devices on the network and maps each discovered device into a gateway registered service as well as presents registered UPnP services to other registered services. Functionality of the UPnP Device Service is preferably implemented by a UPnP Base Driver bundle in accordance with the UPnP Device Service specification. Further information regarding the UPnP Device Service maybe found in the UPnP Device Service specification, Version 1.0 which is incorporated by reference herein. Although the UPnP Device Service 16 has been defined in the OSGi framework, it is envisioned that a similar service could be defined in other service gateway frameworks. Such a service will be generally referred to herein as “UPnP Service”.

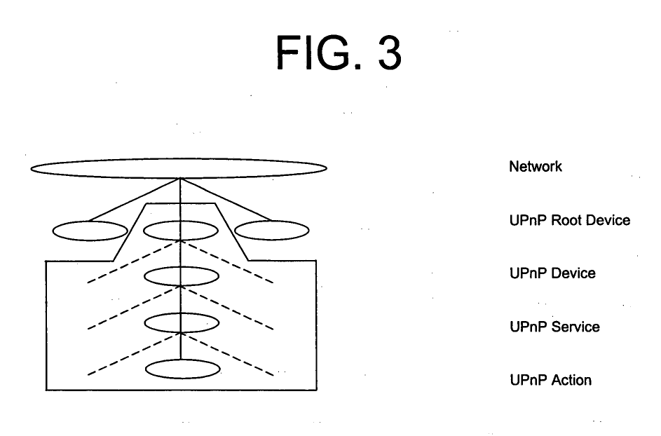

Referring to FIG. 3, the hierarchy of the UPnP Service allows the existence of root UPnP device (parent) and sub-UPnP device (child), all required to register with the OSGi framework in order to be searchable. The parent-child relationship is reflected in the service registration properties (PARENT_UDN, CHILD_UDN) associated with each UPnP device. Therefore, the hierarchy of UPnP devices can be discovered via OSGi framework service tracking services without using UPnP Service APIs. This makes it simple to discover the list of UPnP devices and grab an instance of interested one. Because all UPnP devices are registered on the OSGi framework, the parent-child relationship becomes transparent to the bridging middleware. In the same context, the multiplex of multiple UPnP devices are therefore handled by the OSGi framework.

The SIP/UPnP bridging middleware 18 provides a communication interface between SIP entities residing outside the network gateway environment and UPnP entities residing within the network gateway environment. More specifically, the bridging middleware translates SIP messages from the SIP entities to a series of UPnP-specified APIs as provided by the UPnP Service. The bridging middleware also supports other operations needed to fulfill the bridging function as further described below.

Returning to FIG. 1, a mobile network device 20 residing outside of the network gateway may register with the SIP Service 14 as a SIP device and thereby function as a SIP user agent 22. The mobile network device 20 further includes a middleware layer 24 that understands the contents of SIP messages. The middleware layer 24 provides UPnP control point functionality for any applications 26 residing on the mobile device by converting any UPnP related application logic (e.g., control, subscription, etc.) into SIP messages.

Likewise, the bridging middleware invokes SIP user agent functionality by registering with the SIP Service 14 at the start of middleware execution. In this way, the mobile network device may then communicate with the bridging middleware 18 using SIP messaging. Since the bridging middleware 18 is registered with the gateway framework, it can also communicate with the UPnP Service 16. In order for the bridging middleware to be identified by other SIP user agents or OSGi services, a SIP username and an OSGi bundle display name are used to register with the framework.

To interface with UPnP entities within the network gateway, the bridging middleware 18 supports a series of UPnP-related APIs as provided by the UPnP Service. Exemplary functions supported by the bridging middleware include: get a list of UPnP devices and services; get details (e.g. device descriptions and Icons etc.) associated with a particular UPnP device; get details (e.g. names of actions and state variables) of a particular UPnP Service; get details (e.g. list of all arguments ) associated with a particular UPnP action or all actions; invoke a specific UPnP action; and get details (e.g. eventing type, allowed values etc.) associated with a particular UPnP state variable or all state variables. The message flow for each of these functions is further described below.

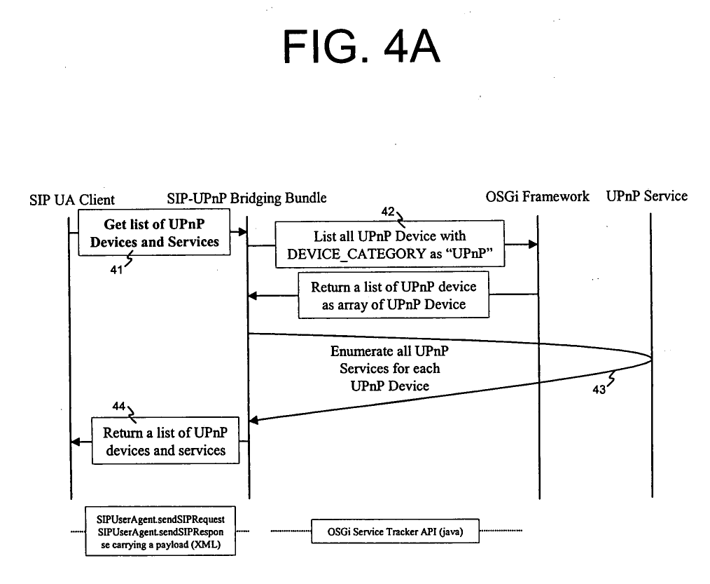

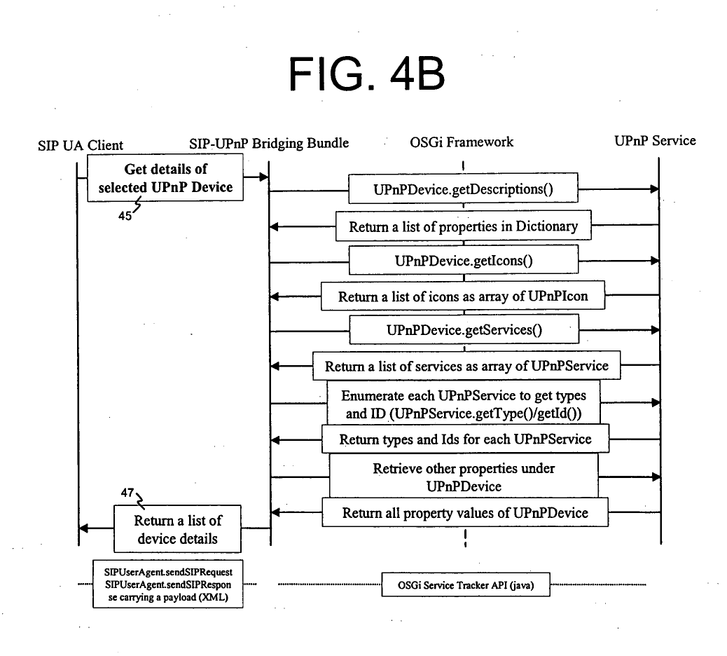

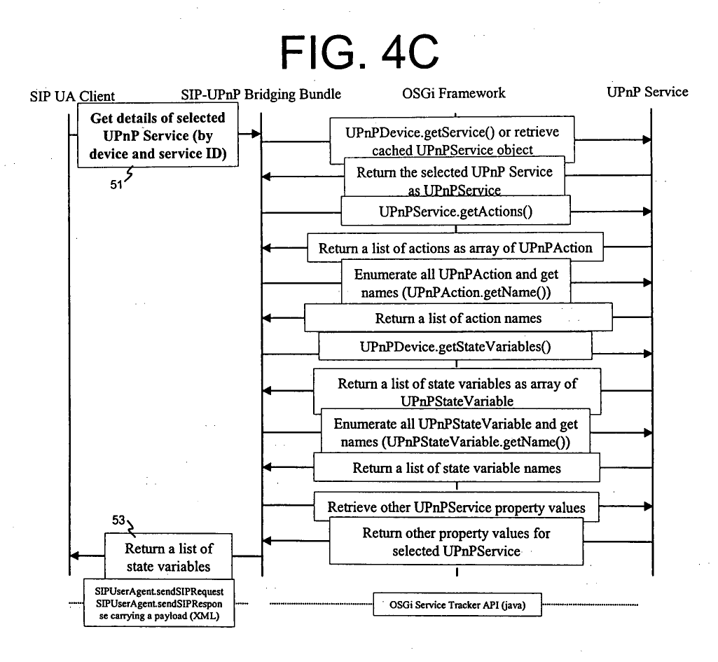

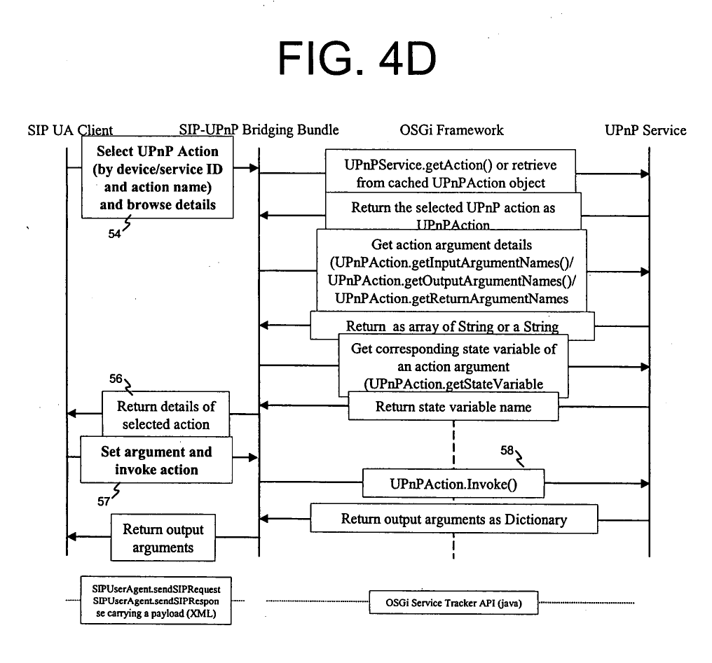

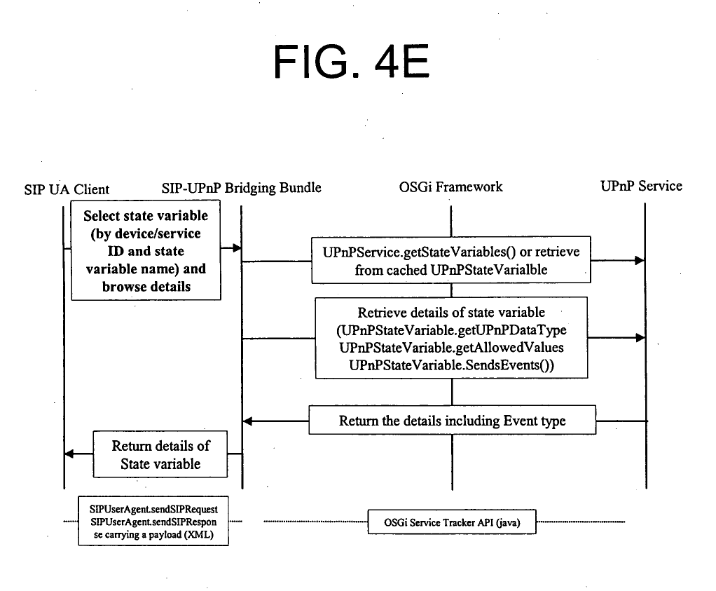

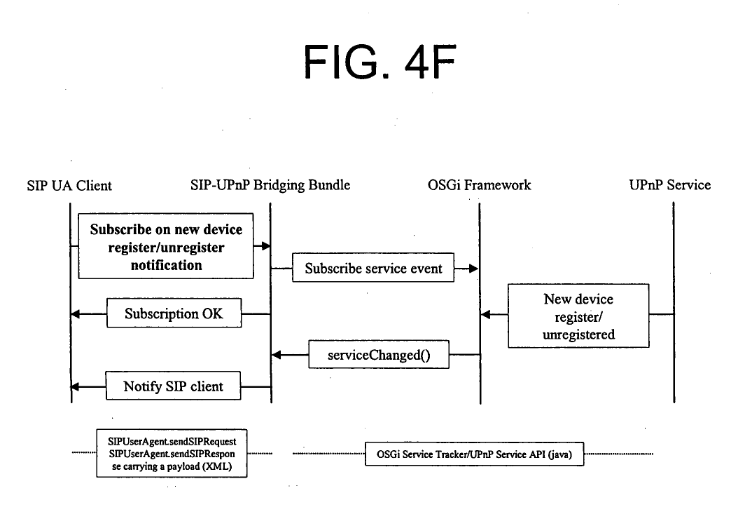

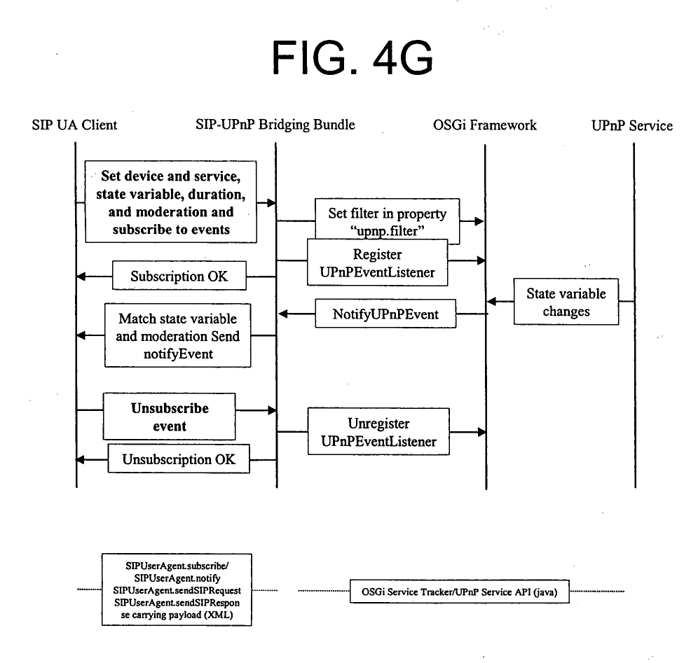

FIG. 4A illustrates a request by a mobile network device for a list of existing UPnP devices and associated services. First, the mobile client can send a SIP message as indicated at 41 requesting the bridging middleware to list all UPnP devices and services on the network. The request is formatted using an XML segment in the payload of a SIP request message. An exemplary XML schema for this request is provided at 4.1 of the appendix below.

Upon receiving the request, the bridging middleware invokes appropriate actions from the OSGi framework as shown at 42. This can be done by listing all devices on the OSGi framework with DEVICE_CATEGORY property as “UPnP”, and a UPnPDevice handle can be obtained from OSGi framework directly for each UPnP device. The description of each UPnP device can be obtained via UPnPDevice action getDescription( ) and the device ID can be obtained from property UPnP.device.UDN (unique device name).

Once UPnPDevice object is obtained, the action getServices( ) can be invoked to obtain information about UPnP services associated with each UPnP device—by returning a UPnPService handle to each service as shown at 43. Each UPnP service can be enumerated by the bridging middleware to obtain the service type and ID via the UPnPService actions getType( ) and getId( ). The final result is a nested data structure representing all devices (description and IDs) and services (service types and IDs) on the network. Services are listed under each device they are associated with. This result is formatted in accordance with an XML scheme into the payload of a SIP response message.

Lastly, the SIP response message is sent from the bridging middleware at 44 to the mobile client. An exemplary XML schema for this response is provided at 4.2 of the appendix below. Device and service identifiers can then be used by the mobile client to select specific device or service of interest. If a device includes a child device, they are both listed in a XML nested structure.

FIG. 4B illustrates how a mobile network device retrieves the details of selected UPnP devices. The details may include icons, descriptions, device ID, descriptions of associated services and their IDs, and all other information (e.g. manufacturer, version, model, serial number, presentation URL etc.) defined in the UPnPDevice class in OSGi UPnP Service specification. A SIP message requesting the details is sent first from the mobile device to the bridging middleware as shown at 45. The bridging middleware then directly interfaces with the selected UPnP service.

Similar to getting services, actions getDescriptions( ) and geticons( ) of UPnPDevice are invoked by bridging middleware to obtain device descriptions and icon information. It should be noted that the descriptions and ID (i.e. UPnP.device.UDN) of each UPnP device and service type and ID of each associated UPnP service are listed redundantly with those returned by Listing UPnP device and service interaction. These are necessary in order to maintain the integrity of information under UPnP device and they can be cached internally by the bridging middleware. Other detailed information about a UPnP device can be obtained via corresponding property values defined in the UPnPDevice class. The requested information for the UPnP device is then sent by the bridging middleware via a SIP response message at 47 to the mobile client.

FIG. 4C illustrates how a mobile network device retrieves the details of selected UPnP services. The details may include names of actions, state variable names, and other property values of UPnPService defined in OSGi UPnP Service specification. A SIP message requesting the details is sent first from the mobile device to the bridging middleware as shown at 51. The bridging middleware then directly interfaces with the selected UPnP service.

To obtain action names, the bridging middleware needs to call getactions() of UPnPService and enumerate each returned UPnPAction objects and retrieve action names via UPnPAction.getName( ). Similarly, state variable names can be retrieved from each State Variable object UPnPStateVaraible, which is returned by UPnPService.getStateVariables( ). Other detailed information about a UPnP service include service type, ID, version etc. and can be obtained from corresponding actions of UPnPService object. The requested detail information is then sent via a SIP response message at 53 from the bridging middleware to the mobile device.

FIG. 4D illustrates how a mobile network device invokes specific UPnP actions. This function involves two steps: browsing details of an interested action and invoking the action.

To browse details of an action, the mobile client sends a request with selected device UDN and service ID, and the action name as indicated at 54. If a wildcard “*” is specified as the action name, the bridging middleware returns details of all actions from the selected device. The returned action details include action names, input argument names and associated state variables, and output argument names, all structured in a XML message.

The bridging middleware first obtains a handle to the UPnPAction object (via UPnPService.getAction or cached previously). Upon obtaining the handle of UPnPAction, the bridging middleware can call its actions getInputArgumentNames( ), getOutputArgumentNames( ), and getReturnArgumentNames() to query details of the given action. In UPnP, each argument of an action has a state variable associated with it. To find out this relation, the method getStateVariable(argumentName) of UPnPAction can be invoked, and an object UPnPStateVariable is returned. The associated state variable name can be parsed by the bridging middleware and returned via SIP message at 56 to the mobile client. Further, the UPnP data type of each corresponding state variable (same as the associated argument of an action) can be obtained via the method UPnPStateVariable.getUPnPDataType( ). This data type is useful for bridging middleware to later assign arguments when invoking an action.

To invoke an action, mobile client needs to set the argument as indicated at 57. These arguments are stored by the bridging middleware in the dictionary data structure prior to invoking the action via UPnPAction.Invokeo. The arguments needed are: names of the device and service of the action to invoke, name of the action, and the values for each argument. It is the responsibility of the bridging middleware to fill in the arguments of the action to invoke and invoke the action at 58. The UPnP Service method used in response is: Dictionary UPnPAction.invoke(Dictionary args).

As indicated, the input arguments are contained in the Dictionary object. Each entry in the Dictionary object has a String object as key representing the argument name and the value in the argument itself. The class of an argument value must be assignable from the class of the associated UPnP State variable. The bridging middleware is responsible for setting the correct Java data type in each argument through a mapping from UPnP data type. This mapping is provided in the UPnP Service of OSGi specification V3.0, particularly in org.osgi.service.upnp pertaining to UPnPStateVariable interface. The input argument Dictionary object must contain exactly those arguments listed by getInputArguments method. The output argument Dictionary object will contain exactly those arguments listed by getOutputArguments method.

FIG. 4E illustrates how a mobile network device gets the details of state variables. A SIP message requesting the details is sent first from the mobile device to the bridging middleware as shown at 61. The user selects the state variable of interest by specifying device/service ID and state variable name. If a wildcard “*” is specified as the state variable name, the bridging middleware returns details of all state variables. The bridging middleware returns all details of the state variable including event type in a XML payload. The details of a state variable to be returned include selected state variable name, java data type, allowed values and eventing type (i.e. whether the state variable is evented).

To interface with the selected UPnP service, the bridging middleware employs the GetState Variables API. GetStateVariables( ) of UPnPService is available to list all state variables associated with the selected UPnP service. The returned is a list of UPnPStateVariables[ ] as an array. The bridging middleware needs to extract the state variable name (String data type) of each UPnPStateVariable and return via SIP message payload to the mobile client. The bridging middleware is also responsible for obtaining detailed information of each state variable. For instance, a Java data type of each state variable may be obtained via UPnPStateVariable.getJavaDataType. This data is useful for OSGi middleware (written in Java) to interpret returned state variable value. In another instance, an eventing type is obtained via UPnPStateVariable.sendsEvents, which returns a Boolean indicating whether the state variable is evented.

FIG. 4F illustrates how a mobile network device learns about device registrations within the OSGi framework. A SIP message requesting device registration notification is sent first from the mobile device to the bridging middleware as shown at 71. The bridging middleware then subscribes to the ServiceChanged( ) action as provided by the OSGi framework. When new UPnP devices are registered or unregistered with OSGI framework, the ServiceChanged( ) action provides a notification message at 73 to the bridging middleware. The bridging middleware in turn sends a SIP response message at 75 to the requesting client, where the SIP response message includes identifying information for the newly registered or unregistered UPnP device.

FIG. 4G illustrates how a mobile network device may receive event notification from a UPnP device. Due to its relatively high volume of network traffic, UPnP event notification is typically limited to network devices that are connected in a network environment where multicasting is supported. Since SIP does not adequately support this type of network traffic, bridging support for this feature requires special attention. In particular, the bridging middleware provides a moderating function for event notification traffic between a requesting mobile device and the gateway framework, where moderating may occur on a state variable basis or some other user customization moderation parameter.

In operation, the bridging middleware receives a subscription request from the mobile network device, where the subscription request specifies the state variables of interest, a duration for being notified about changes to these state variables as well as other user customizable parameters. The bridging middleware translates the subscription request into a subscription with the OSGi framework. In an exemplary embodiment, the bridging middleware instantiates an UPnPEventListener object by means of the OSGi Whiteboard model. To so do, the bridging middleware must set a filter according to the device and service names specified in the subscription request and then register with the OSGI framework. The UPnPEventListener will in turn report all events from the requested service to the bridging middleware.

To further moderate network traffic to the mobile device, the bridging middleware will filter the events in accordance with the subscription request. For example, the bridging middleware is operable to match each incoming event by name to the names of the state variables specified in the subscription request. If there is a match, the event is sent via a SIP notification message to the mobile device. Conversely, if there is not a match, then the event is discarded. Further information regarding an exemplary event moderating function may be found in U.S. patent application Ser. No. ______ entitled “Event Moderation for Event Publishing Environments” which is filed currently herewith and incorporated herein by reference.

Upon termination, the bridging middleware cleans up all memory buffers, intermediate data structures such as eventing template, and UPnP object instances etc. Although they are not the actions of the bridging middleware directly, a series of architecture-specific events also occur upon the stop of the bridging bundle. First, the stop of the middleware should be detected (evented) by the OSGi framework and SIP Service. OSGi framework and SIP Service un-register the bridging middleware from their own registries. This un-registration at SIP Service should be seen at all other SIP user agents that are connected to the bridging middleware through SIP protocol.

The description of the invention is merely exemplary in nature and, thus, variations that do not depart from the gist of the invention are intended to be within the scope of the invention. Such variations are not to be regarded as a departure from the spirit and scope of the invention.

APPENDIX
4.1 SIP request message

<?xml version=“1.0” encoding=“UTF-8”?>
<xs:schema xmlns:xs=“http://www.w3.org/2001/XMLSchema” elementFortnDefault=“qualifie [symbol]
attributeFormDefault=“unqualified”>

<xs:element name=“request”>

<xs:annotation>

<xs:documentation>The root element for UPnP2SIP BB requests</xs:documentation>

</xs:annotation>
<xs:complexType>

<xs:choice>

<xs:element name=“devices”/>
<xs:element name=“device_info”>

<xs:complexType>

<xs:attribute name=“udn” type=“xs:ID” use=“required”/>

</xs:complexType>

</xs:element>
<xs:element name=“icon”>

<xs:complexType>

<xs:attribute name=“udn” type=“xs:ID” use=“required”/>
<xs:attribute name=“locale” type=“xs:string” use=“required”/>
<xs:attribute name=“id” type=“xs:decimal” use=“required”/>

</xs:complexType>

</xs:element>
<xs:element name=“invoke”>

<xs:complexType>

<xs:sequence>

<xs:element name=“argument” maxOccurs=“unbounded”>

<xs:complexType>

<xs:attribute name=“name” type=“xs:string” use=“required”/>
<xs:attribute name=“value” type=“xs:normalizedString” use=“required”/>

</xs:complexType>

</xs:element>

</xs:sequence>
<xs:attribute name=“udn” type=“xs:ID” use=“required”/>
<xs:attribute name=“service_id” type=“xs:ID” use=“required”/>
<xs:attribute name=“action_name” type=“xs:string” use=“required”/>

</xs:complexType>

</xs:element>
<xs:element name=“service_info”>

<xs:complexType>

<xs:attribute name=“udn” type=“xs:ID” use=“required”/>
<xs:attribute name=“service_id” type=“xs:ID” use=“required”/>

</xs:complexType>

</xs:element>
<xs:element name=“state_variable_info”>

<xs:complexType>

<xs:attribute name=“udn” type=“xs:ID” use=“required”/>
<xs:attribute name=“service_id” type=“xs:ID” use=“required”/>
<xs:attribute name=“name” type=“xs:string” use=“required”/>

</xs:complexType>

</xs:element>
<xs:element name=“action_info”>

<xs:complexType>

<xs:attribute name=“udn” type=“xs:ID” use=“required”/>
<xs:attribute name=“service_id” type=“xs:ID” use=“required”/>
<xs:attribute name=“name” type=“xs:string” use=“required”/>

</xs:complexType>

</xs:element>

</xs:choice>

</xs:complexType>

</xs:element>

</xs:schema>

4.2 SIP response message

<?xml version=“1.0” encoding=“UTF-8”?>
<xs:schema xmlns:xs=“http://www.w3.org/2001/XMLSchema”
elementFormDefault=“qualified” attributeFormDefault=“unqualified”>

<xs:element name=“response”>

<xs:annotation>

<xs:documentation>Response</xs:documentation>

</xs:annotation>
<xs:complexType>

<xs:choice>

<xs:element name=“invoke”>

<xs:complexType>

<xs:sequence>

<xs:element name=“argument” maxOccurs=“unbounded”>

<xs:complexType>

<xs:attribute name=“name” type=“xs:string” use=“required”/>
<xs:attribute name=“value” type=“xs:string” use=“required”/>

</xs:complexType>

</xs:element>

</xs:sequence>
<xs:attribute name=“udn” type=“xs:ID” use=“required”/>
<xs:attribute name=“service_id” type=“xs:ID” use=“required”/>
<xs:attribute name=“action_name” type=“xs:string” use=“required”/>

</xs:complexType>

</xs:element>
<xs:element name=“icon”>

<xs:complexType>

<xs:simpleContent>

<xs:extension base=“xs:hexBinary”>

<xs:attribute name=“udn” type=“xs:ID” use=“required”/>
<xs:attribute name=“locale” type=“xs:string” use=“required”/>
<xs:attribute name=“mime_type” use=“required”>

<xs:simpleType>

<xs:restriction base=“xs:string”>

<xs:pattern value=“\w+/\w+”/>

</xs:restriction>

</xs:simpleType>

</xs:attribute>
<xs:attribute name=“id” type=“xs:decimal” use=“required”/>

</xs:extension>

</xs:simpleContent>

</xs:complexType>

</xs:element>
<xs:element name=“error”>

<xs:complexType>

<xs:attribute name=“code” use=“required”>

<xs:simpleType>

<xs:restriction base=“xs:decimal”>

<xs:minInclusive value=“0”/>
<xs:maxInclusive value=“999”/>
<xs:pattern value=“\d\d\d”/>

</xs:restriction>

</xs:simpleType>

</xs:attribute>
<xs:attribute name=“message” use=“required”>

<xs:simpleType>
<xs:restriction base=“xs:string”/>

</xs:simpleType>

</xs:attribute>

</xs:complexType>

</xs:element>
<xs:element name=“service_info”>

<xs:complexType>

<xs:sequence>

<xs:element name=“state_variable” maxOccurs=“unbounded”>

<xs:complexType>

<xs:attribute name=“name” type=“xs:string” use=“required”/>

</xs:complexType>

</xs:element>
<xs:element name=“action” maxOccurs=“unbounded”>

<xs:complexType>

<xs:attribute name=“name” type=“xs:string” use=“required”/>

</xs:complexType>

</xs:element>

</xs:sequence>
<xs:attribute name=“type” type=“xs:ID” use=“required”/>
<xs:attribute name=“service_id” type=“xs:ID” use=“required”/>
<xs:attribute name=“version” type=“xs:string” use=“required”/>

</xs:complexType>

</xs:element>
<xs:element name=“state_variable_info”>

<xs:complexType>

<xs:sequence>

<xs:element name=“allowed_values” minOccurs=“0” maxOccurs=“unbounded”>

<xs:complexType>

<xs:attribute name=“value” type=“xs:normalizedString” use=“required”/>

</xs:complexType>

</xs:element>

| </xs:sequence> | | |
|---|---|---|
| <xs:attribute name=“name” type=“xs:string” use=“required”/> | | |
| <xs:attribute name=“upnp_type” type=“xs:string” use=“required”/> | | |
| <xs:attribute name=“post_events” type=“xs:boolean” use=“required”/> | | |
| <xs:attribute | name=“default_value” | type=“xs:normalizedString” |

use=“required”/>

<xs:attribute name=“minimum” type=“xs:double” use=“required”/>
<xs:attribute name=“maximum” type=“xs:double” use=“required”/>
<xs:attribute name=“step” type=“xs:double” use=“required”/>
<xs:attribute name=“java_type” type=“xs:string” use=“required”/>

</xs:complexType>

</xs:element>
<xs:element name=“action_info”>

<xs:complexType>

<xs:sequence>

<xs:element name=“parameter” maxOccurs=“unbounded”>

<xs:complexType>

<xs:attribute name=“name” type=“xs:string” use=“required”/>
<xs:attribute name=“direction” use=“required”>

<xs:simpleType>

<xs:restriction base=“xs:string”>

<xs:enumeration value=“in”/>
<xs:enumeration value=“out”/>

</xs:restriction>

</xs:simpleType>

| </xs:attribute> | | |
|---|---|---|
| <xs:attribute name=“is_return” type=“xs:boolean” use=“required”/> | | |
| <xs:attribute | name=“state_variable_name” | type=“xs:string” |

use=“required”/>

</xs:complexType>

</xs:element>
</xs:sequence>
<xs:attribute name=“name” type=“xs:string” use=“required”/>

</xs:complexType>

</xs:element>
<xs:element name=“device_info”>

<xs:complexType>

<xs:sequence>

<xs:element name=“property” maxOccurs=“unbounded”>

<xs:complexType>

<xs:attribute name=“name” type=“xs:string” use=“required”/>
<xs:attribute name=“value” type=“xs:normalizedString” use=“required”/>

</xs:complexType>

</xs:element>
<xs:element name=“service” maxOccurs=“unbounded”>

<xs:complexType>

<xs:attribute name=“service_id” type=“xs:ID” use=“required”/>

</xs:complexType>

</xs:element>

</xs:sequence>
<xs:attribute name=“number_of_icons” type=“xs:decimal” use=“required”/>

</xs:complexType>

</xs:element>
<xs:element name=“devices”>

<xs:complexType>

<xs:sequence>

<xs:element name=“device” maxOccurs=“unbounded”>

<xs:complexType>

<xs:sequence>

<xs:element name=“service” maxOccurs=“unbounded”>

<xs:complexType>

<xs:attribute name=“service_id” type=“xs:ID” use=“required”/>

</xs:complexType>

</xs:element>

</xs:sequence>
<xs:attribute name=“udn” type=“xs:ID” use=“required”/>

</xs:complexType>

</xs:element>

</xs:sequence>

</xs:complexType>

</xs:element>

</xs:choice>

</xs:complexType>

</xs:element>

</xs:schema>

What is claimed is:

1. A bridging architecture for a network gateway environment which provides service registration in accordance with a gateway framework, comprising:
a SIP service registered with the gateway framework and operable to import and export SIP capabilities into the network gateway environment;
a UPnP Service registered with the gateway framework and operable to import UPnP capabilities into the network gateway environment; and
a SIP/UPnP bridging middleware registered with the gateway framework and with the SIP service as a SIP user agent, such that the bridging middleware provides a communication interface between SIP entities residing outside the network gateway environment and UPnP entities residing within the network gateway environment.

2. The bridging architecture of claim 1 wherein SIP entities residing outside the network gateway environment are further defined as mobile devices that are registered with the SIP service.

3. The bridging architecture of claim 2 wherein the mobile devices include a middleware layer that provides control point functionality for applications residing on the mobile devices.

4. The bridging architecture of claim 1 wherein the SIP service enables SIP entities to register with itself and translates such registrations into registrations with the gateway framework.

5. The bridging architecture of claim 1 wherein the SIP service instantiates an instance of a SIP registration/proxy server.

6. The bridging architecture of claim 1 wherein the gateway framework is further defined in accordance with an Open Services Gateway Initiative (OSGi) specification, such that the SIP service is registered with and discoverable via an OSGi registry.

7. The bridging architecture of claim 1 wherein the gateway framework is further defined in accordance with an Open Services Gateway Initiative (OSGi) specification, such that the SIP service enables registration of SIP entities with an OSGi registry.

8. The bridging architecture of claim 1 wherein the bridging middleware is operable to translate SIP messages received from the SIP entities and invoke a series of application program interfaces provided by the UPnP service.

9. The bridging architecture of claim 1 wherein the application program interfaces supported by the bridging middleware are selected from a group consisting of get a list of UPnP devices and services; get associated with a particular UPnP device; get details of a particular UPnP service; get details associated with a particular UPnP action; invoke a specific UPnP action; get details associated with a particular UPnP state variable; subscribe and receive event notification for UPnP state variables; and subscribe to UPnP device registration/unregistration with the framework.

10. A bridging architecture for a network gateway environment defined in accordance with the Open Services Gateway Initiative (OSGi), comprising:
a SIP service defined in accordance with OSGi and operable to import and export SIP capabilities into the network gateway environment;
a UPnP service defined in accordance with OSGi and operable to import UPnP capabilities into the network gateway environment; and
a SIP/UPnP bridging bundle defined in accordance with OSGi and operable to register with the SIP service as a SIP user agent, wherein the bridging bundle translates SIP messages from the SIP entities residing outside the network gateway environment and invoke a series of UPnP-specified application program interfaces as provided by the UPnP Service.

11. The bridging architecture of claim 10 wherein the application program interfaces supported by the bridging bundle are selected from a group consisting of get a list of UPnP devices and services; get associated with a particular UPnP device; get details of a particular UPnP service; get details associated with a particular UPnP action; invoke a specific UPnP action; get details associated with a particular UPnP state variable; subscribe and receive event notification for UPnP state variables; and subscribe to UPnP device registration/unregistration with the framework.

12. The bridging architecture of claim 10 wherein SIP entities residing outside the network gateway environment are further defined as mobile devices that registered with the SIP service.

13. The bridging architecture of claim 12 wherein the mobile devices include a middleware layer that provides control point functionality for application residing on the mobile devices.

14. The bridging architecture of claim 10 wherein the SIP service enables SIP entities to register with itself and translates such registrations into registrations with the gateway framework.

15. The bridging architecture of claim 10 wherein the SIP service instantiates an instance of a SIP registration/proxy server.

16. The bridging architecture of claim 10 wherein the SIP service is registered with and discoverable via an OSGi registry.

17. The bridging architecture of claim 10 wherein the SIP service enables registration of SIP entities with an OSGi registry.

18. The bridging architecture of claim 10 wherein the SIP/UPnP bridging bundle registers with the SIP service and the OSGi framework upon execution of the bridging bundle.

19. The bridging architecture of claim 10 wherein the SIP service and OSGi framework detects termination of the SIP/UPnP bridging bundle and un-registers the bridging bundle in response thereto.

20. A bridging architecture for a network gateway environment which provides service registration in accordance with a gateway framework, comprising:
a SIP service registered with the gateway framework and operable to import and export SIP capabilities into the network gateway environment;
a plurality of network devices registered with the gateway framework and operable in accordance with a service oriented protocol; and
a SIP/UPnP bridging middleware registered with the gateway framework and with the SIP service as a SIP user agent, such that the bridging middleware provides a communication interface between SIP entities residing outside the network gateway environment and the plurality of network devices residing within the network gateway environment.

21. The bridging architecture of claim 20 wherein SIP entities residing outside the network gateway environment are further defined as mobile devices that are registered with the SIP service.

22. The bridging architecture of claim 21 wherein the mobile devices include a middleware layer that provides control point functionality for applications residing on the mobile devices.

23. The bridging architecture of claim 20 wherein the SIP service enables SIP entities to register with itself and translates such registrations into registrations with the gateway framework.

24. The bridging architecture of claim 20 wherein the SIP service instantiates an instance of a SIP registration/proxy server.

25. The bridging architecture of claim 20 wherein the gateway framework is further defined in accordance with an Open Services Gateway Initiative (OSGi) specification, such that the SIP service is registered with and discoverable via an OSGi registry.

26. The bridging architecture of claim 20 wherein the gateway framework is further defined in accordance with an Open Services Gateway Initiative (OSGi) specification, such that the SIP service enables registration of SIP entities with an OSGi registry.

27. The bridging architecture of claim 20 wherein the bridging middleware is operable to translate SIP messages received from the SIP entities to a series of application program interfaces provided by the UPnP service.

28. The bridging architecture of claim 20 wherein the plurality of network device are operable tin accordance with Universal Plug and Play protocol.
